(19) United States
(12) Patent Application Publication
(10) Pub. No.: US 2025/0387735 A1
(43) Pub. Date: Dec. 25, 2025

(54) FILTER ASSEMBLY FOR A FILTER PRESS

(71) Applicant: MICRONICS, INC., Portsmouth, NH (US)

(72) Inventors: Terry Allen MORLEY, Hixson, TN (US); Noah Riley LIVINGSTON, Hixson, TN (US)

(21) Appl. No.: 19/248,957

(22) Filed: Jun. 25, 2025

Related U.S. Application Data
(60) Provisional application No. 63/663,998, filed on Jun. 25, 2024.

(51) Int. Cl. B01D 25/21

(52) U.S. Cl. CPC B01D 25/215

(57) ABSTRACT

A filter assembly that includes a flange assembly and a neck assembly. The flange assembly has a first flange component and a second flange component, wherein at least a portion of the first flange component and the second flange component are configured to seat within a feed hole. The neck assembly has a first neck component configured to be coupled to a first filter cloth and mountable on a first side of the filter plate and a second neck component configured to be coupled to a second filter cloth and mountable on a second opposed side of the filter plate. Further, at least a portion of the first neck component is configured to be coupled to the first flange component in the feed hole and at least a portion of the second neck component is configured to be coupled to the second neck component in the feed hole.

### RELATED APPLICATION

The present application claims priority to U.S. provisional patent application Ser. No. 63/663,998, filed on Jun. 25, 2024, entitled Control Flange For Filter Media, the contents of which are herein incorporated by reference.

### BACKGROUND OF THE INVENTION

A filter press is an economical and efficient liquid/solid separation device commonly utilized in the clay, chemical, or mining industries. Filter presses generally employ a plurality of filter plates, each filter plate having large areas of a textile material to form a filtering screen. The textile material is typically attached to a cloth, rubber or plastic tubular hub or neck, to form a connecting neck or flange. The connecting neck allows the material to be filtered to pass through successive filtering chambers in the press. The connecting neck can be securely attached to the filtering material to prevent leakage.

The connecting neck also typically joins together a pair of opposed filter panels to form a filter assembly that can be mounted on opposed sides of a filter plate. As such, the filter assembly can be difficult to install and to remove from the filter plate. In the current state of the art, filter cloth is generally installed on the filter plates by rolling up one side of a duplex filter cloth, which is joined at a feed hole with the tubular hub, and then pushing the rolled up filter cloth through the feed hole of the filter plate. After passing the rolled cloth through the feed hole, the filter cloth is then unrolled. The filter plate thus has a layer of filter cloth on either side thereof, and the two filter cloth layers are fastened together on the filter plate. A feed fluid, such as a slurry, is pumped into the filter press through a central feed hole and fills each cavity within the stack of filter plates. Any solid material in the slurry remains in the chambers and the remaining filtrate portion of the slurry passes through the filter cloth, exiting the filter plate through filtration passages.

Conventional single piece neck filter cloths require one side to be rolled into a tube, folded in half, and then pulled thru the filter plate. This allows for single panel installation, but also requires grooves to be machined into the surface of the filter plate, which is difficult to do, is expensive and mars the filter plate, and which also requires a distribution ring to be installed into the clip neck to assist with sealing efficiency to the filter plate.

Conventional methods for joining the filtering material to the connecting neck or flange include sewing the two filter cloth layers together. This approach is labor intensive and thus expensive. Moreover, the sewing tends to create weaknesses in the joint due to the stitch holes. Stitching can also be difficult due to the thickness of the filter cloth and the tubular hub. Other methods include adhesive and bonding agents to secure the filtering cloth to the connecting neck, but these techniques are time consuming since the adhesive must set to form the bond and is not consistently reliable. Welding requires a split clamping collar positioned between the flanges of the feed neck to transmit force to the weld from a clamping cylinder.

U.S. Pat. No. 4,765,859 describes a method of joining filter cloth to a rubber connecting neck for use as a filter screen, which is installed on a filtering plate in a filtering press. The connecting neck consists of a cylindrical tube that includes two annular flanges protruding radially outward from the circumference of the tube at each end. The connecting neck is fabricated from a rubber material that is collapsible. A filtering screen is then constructed by joining two filter cloths to the hub at each end of the tube. One filter cloth is joined to the connecting neck at the inside surface of one flange, while the other filter cloth is joined to the inside surface of the other flange. The filter cloth and connecting neck are bonded together by induction heating to form a seal to prevent leakage of the filtered material. U.S. Pat. No. 5,958,173, the contents of which are herein incorporated by reference, describes a method of fabricating a filter screen for a filter press by attaching a filter cloth to a tubular hub using induction heating.

The methods in the prior art of attaching a filter cloth to a filter plate also pose a number of disadvantages. The prior methods of installing filter cloths are difficult and time consuming, particularly for larger filters. The large filter cloth requires a person on each side of the filter plate, namely, one person to push the filter cloth through the hole, and the other person to receive the filter cloth. Large presses are usually re-clothed without removing plates, requiring operators to get between the plates physically, sometimes on platforms above conveyors or high above the ground level, a procedure that can be dangerous. The removal of filter plates in order to replace the filter cloths causes significant losses in productivity, as the filter press cannot be used during the replacement process.

Furthermore, the duplex-type of filter cloths used in the prior art can be expensive, as both layers of a duplex filter cloth must be removed and replaced when a hole forms in only one of the layers. The process of assembling the duplex filter cloths on a flanged tube for attachment to a filter plate is also complex and unwieldy.

### SUMMARY OF THE INVENTION

The present invention is directed to a filter assembly having a flange assembly for coupling to a filter plate or a neck assembly for coupling to a filter cloth, or both. The flange assembly can be configured to seat within a feed hole formed in the filter plates to form a stable connection point for the neck assembly that corresponds to the specific thickness of the filter plate. The neck assembly of the present invention can be coupled or connected to the flange assembly to secure the neck assembly thereto and hence to the filter plate. The neck assembly can be configured so as to have a first neck component that is coupled to a first filter cloth and capable of being mounted on a first side of the filter plate and a second neck component that is coupled to a second filter cloth that is capable of being mounted on a second or opposed side of the filter plate. The first and second neck components form the neck assembly and are coupled or connected to the flange assembly. The neck components attach directly to the flange assembly, facilitating the easy installation of the filter cloth on each side of the filter plate without the necessity of passing the filter cloth through the feed hole. Further, the separate neck components of the neck assembly enable the filter cloth to be easily mounted on each side of the filter plate without requiring the filter cloth to be passed through the feed hole formed in the filter plate. The design of the filter assembly of the present invention effectively addresses conventional challenges associated with filter assemblies that typically employ a central connecting flange or neck, which generally attaches to a filter cloth on either end. Still further, a primary reason for the problems associated with conventional connecting necks or flanges is the varying feed hole diameters and thicknesses of the filter plates. Due to the many variables in filter plate designs, a single connecting flange or neck configuration would not fit all filter plate designs without needing a specific design for each filter plate thickness and diameter. This would increase the number of connecting flanges that need to be provided and stocked. The combination of the neck assembly and the flange assembly of the preset invention provides a solution by allowing a properly sized flange assembly to be provided to form a single connection hub or point, and then the neck assembly can be employed to couple to the flange assembly. The neck components of the neck assembly provide a single-panel filter cloth that can be attached to the filter plate on each side, quickly and independently. This eliminates the different feed hole variables since the flange assembly is installed once on the filter plate to form the connecting hub to which the neck assembly can be attached.

The present invention is directed to a filter assembly for use with one or more filter plates in a filter press. The filter plate has a feed hole formed therein. The filter assembly includes a flange assembly and a neck assembly. The flange assembly has a first flange component and a second flange component, wherein at least a portion of the first flange component and the second flange component are configured to seat within the feed hole. The neck assembly has a first neck component configured to be coupled to a first filter cloth and mountable on a first side of the filter plate and a second neck component configured to be coupled to a second filter cloth and mountable on a second opposed side of the filter plate. Further, at least a portion of the first neck component is configured to be coupled to the first flange component in the feed hole and at least a portion of the second neck component is configured to be coupled to the second neck component in the feed hole.

The first flange component has a first leg portion configured to seat within the feed hole and a second leg portion configured to overlie a portion of the first side of the filter plate. The first leg component of the first flange component has a first groove formed therein for seating a portion of a first retaining element. The second flange component has a first leg portion configured to seat within the feed hole and a second leg portion configured to overlie a portion of the second side of the filter plate. The first leg component of the second flange component has a second groove formed therein for seating a portion of a second retaining element.

The first neck component has a first leg portion configured to seat within the feed hole and positioned to overlie the first leg portion of the first flange component and a second leg portion configured to be coupled to the first filter cloth. The first leg component of the first neck component has a first groove formed therein for seating a portion of the first retaining element. The second neck component has a first leg portion configured to seat within the feed hole and positioned to overlie the first leg portion of the second flange component and a second leg portion configured to be coupled to the second filter cloth. The first leg component of the second neck component has a second groove formed therein for seating a portion of the second retaining element. Further, the first leg portion of each of the first and second neck components has a second groove formed therein for seating a sealing element, wherein the sealing elements form a seal between the neck assembly and the flange assembly. Still further, the first leg portions of the first and second flange components are configured to be secured together in the feed hole to secure the first and second flange components to the filter plate. The first retaining element secures the first neck component to the first flange component and the second retaining element secures the second neck component to the second flange component.

The filter assembly can also employ a first intermediate element for coupling the first filter cloth to the first neck component and a second intermediate element for coupling the second filter cloth to the second neck component. According to different embodiments, the first leg portion of the first flange component can include an extension component formed at a terminal end thereof.

The first leg component of the first neck component can have a sealing groove formed therein for seating a first sealing element, and the first leg component of the second neck component can have a sealing groove formed therein for seating a second sealing element. The first and second sealing elements form a seal between the neck assembly and the flange assembly. The first flange component can have a first leg portion configured to seat within the feed hole and a second leg portion configured to overlie a portion of the first side of the filter plate. The second flange component can have a first leg portion configured to seat within the feed hole and a second leg portion configured to overlie a portion of the second side of the filter plate. The first neck component has a first leg portion configured to seat within the feed hole and positioned to overlie the first leg portion of the first flange component and a second leg portion configured to be coupled to the first filter cloth, and the second neck component has a first leg portion configured to seat within the feed hole and positioned to overlie the first leg portion of the second flange component and a second leg portion configured to be coupled to the second filter cloth. Further, the first leg portion of the first flange component has a first surface feature associated therewith and wherein the first leg portion of the second flange component has a second surface feature associated therewith. The first leg portion of the first neck component has a first retaining assembly associated therewith and the first leg portion of the second neck component has a second retaining assembly associated therewith. The first retaining assembly includes a plurality of teeth elements configured for coupling to the first surface feature for coupling together the first leg portion of the first neck component to the first leg portion of the first flange component, and wherein the second retaining assembly includes a plurality of teeth elements configured for coupling to the second surface feature for coupling together the first leg portion of the second neck component to the first leg portion of the second flange component. The first surface feature and the second surface feature can include a protrusion. The first leg component of the first flange component has a first groove formed therein that is sized and configured for seating a first sealing element and wherein the first leg component of the second flange component has a second groove formed therein that is sized and configured for seating a second sealing element.

According to another embodiment or aspect, the present invention is directed to a filter assembly for use with one or more filter plates in a filter press, wherein the filter plate has a feed hole formed therein. The filter assembly includes a flange component mounted on a first side of the filter plate and having a first leg portion that is configured to seat within the feed hole and a second leg portion that is configured to be coupled to a first filter cloth, and a neck component separate and distinct from the flange component mounted on a second side of the filter plate and having a first leg portion that is configured to seat within the feed hole and configured to be coupled to the first leg portion of the flange component and a second leg portion that is configured to be coupled to a second filter cloth. The first leg portion of the flange component has a flange surface feature associated therewith and the first portion of the neck component has a neck surface feature associated therewith. The flange surface feature and the neck surface feature are configured to be coupled together to secure the flange component to the neck component. The neck surface feature includes a plurality of retaining elements and wherein the flange surface feature includes one or more protrusions. The plurality of retaining elements can include a plurality of teeth elements.

According to another embodiment or aspect, the present invention is directed to a filter assembly for use with one or more filter plates in a filter press, wherein the filter plate has a feed hole having a first annular protrusion and a second annular protrusion formed thereon. The filter assembly includes a first neck component mounted on a first side of the filter plate and having a first leg portion that is configured to seat within the feed hole and a second leg portion that is configured to be coupled to a first filter cloth. The first leg portion has a first surface feature formed thereon configured for coupling to the first annular protrusion of the feed hole to secure the first neck component to the first side of the filter plate, and a second neck component mounted on a second side of the filter plate and having a first leg portion that is configured to seat within the feed hole and a second leg portion that is configured to be coupled to a second filter cloth. The first leg portion has a second surface feature formed thereon configured for coupling to the second annular protrusion of the feed hole to secure the second neck component to the second side of the filter plate. The first surface feature includes a plurality of retaining elements and wherein the second surface feature includes a plurality of retaining elements.

### BRIEF DESCRIPTION OF THE DRAWINGS

These and other features and advantages of the present invention will be more fully understood by reference to the following detailed description in conjunction with the attached drawings in which like reference numerals refer to like elements throughout the different views. The drawings illustrate principals of the invention and, although not to scale, show relative dimensions.

FIG. 1 is a partial cross-sectional exploded view of a first embodiment of a filter assembly showing a flange assembly that can be coupled to a filter plate and a neck assembly that is coupled to filter cloth that can be coupled to the flange assembly according to the teachings of the present invention.

FIG. 2 is a partial cross-sectional view of one neck component of the neck assembly attached to a filter cloth for mounting on one side of the filter plate according to the teachings of the present invention.

FIG. 3 is a partial cross-sectional view of the flange assembly of the filter assembly of FIG. 1 coupled to the filter plate according to the teachings of the present invention.

FIG. 4 is a partial cross-sectional assembled view of the filter assembly of FIG. 1 according to the teachings of the present invention.

FIG. 5 is a partial cross-sectional view of the filter assembly of FIG. 1 according to the teachings of the present invention.

FIG. 6 is a cross-sectional view of a flange component of the flange assembly according to the teachings of the present invention.

FIG. 7 is a cross-sectional view of another flange component of the flange assembly according to the teachings of the present invention.

FIG. 8 is a cross-sectional view of another embodiment of the filter assembly according to the teachings of the present invention.

FIG. 9 is a cross-sectional view of yet another embodiment of the filter assembly according to the teachings of the present invention.

FIG. 10 is still another embodiment of the filter assembly according to the teachings of the present invention.

FIG. 11 is a perspective view of a flange component of the flange assembly of FIG. 10 according to the teachings of the present invention.

FIG. 12 is a perspective view of a neck component of the neck assembly of the filter assembly of FIG. 10 according to the teachings of the present invention.

FIG. 13 is a perspective view of another neck component of the neck assembly of the filter assembly of FIG. 10 according to the teachings of the present invention.

FIG. 14 is a cross-sectional view of the filter assembly of FIG. 10 according to the teachings of the present invention.

FIG. 15 is a perspective view of another embodiment of the filter assembly employing a neck component and a flange component according to the teachings of the present invention.

FIG. 16 is a cross-sectional view of the filter assembly of FIG. 15 according to the teachings of the present invention.

FIG. 17 is a perspective view of still another embodiment of the filter assembly employing multiple neck components according to the teachings of the present invention.

FIG. 18 is a cross-sectional view of the filter assembly of FIG. 17 according to the teachings of the present invention.

### DETAILED DESCRIPTION OF THE INVENTION

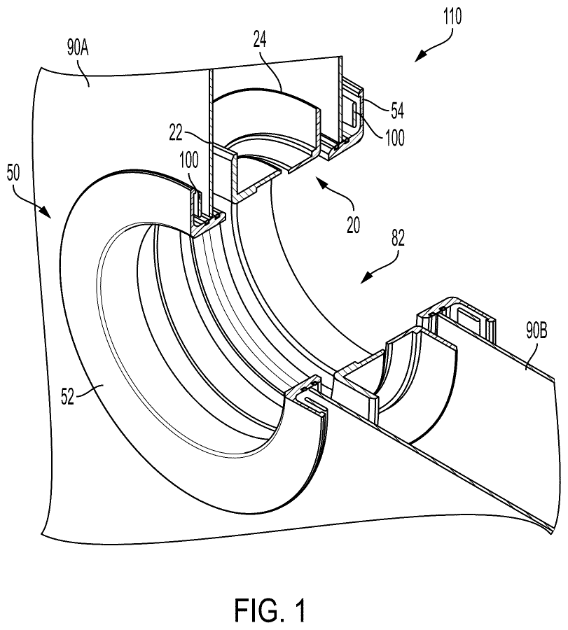

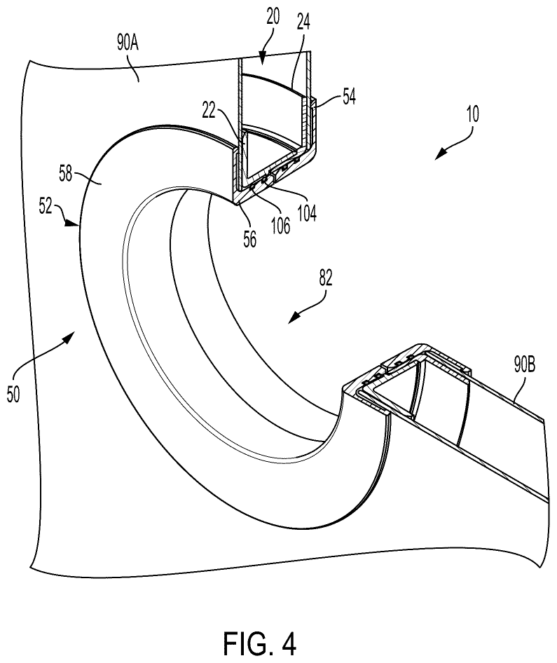

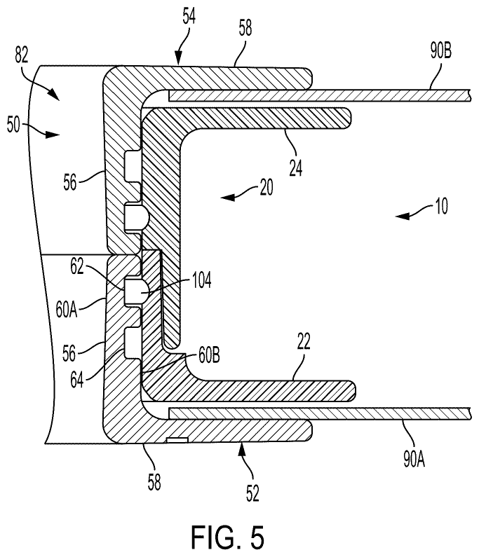

One embodiment of the filter assembly of the present invention is shown, for example, in FIGS. 1-5. The illustrated filter assembly 10 includes a flange assembly 20 that can be coupled to a neck assembly 50. The flange assembly 20 can be coupled to a filter plate 80 by seating within a feed hole 82 of the filter plate. The neck assembly 50 can be coupled to one or more sheets of filter cloth 90A, 90B. The illustrated flange assembly 20 can be formed from a first flange component 22 and from a second flange component 24. The first and second flange components 22, 24 can be seated within the feed hole 82 of the filer plate 80 and can be coupled or secured together so as to mount and retain the flange assembly 20 within the feed hole 82. The neck assembly 50 can also include a first neck component 52 and a second neck component 54. The first neck component 52 can be secured to the filter cloth 90A and the second neck component can be secured to the filter cloth 90B. The neck components 52, 54 can be secured to the filter cloth through any suitable securing or fixation technique, such as by an adhesive or by welding, such as radio frequency welding. The filter cloth can be secured directly to the neck components or can be secured to a suitable intermediate component 100, such as a polypropylene ring, which can be secured to or mechanically retained by the neck components.

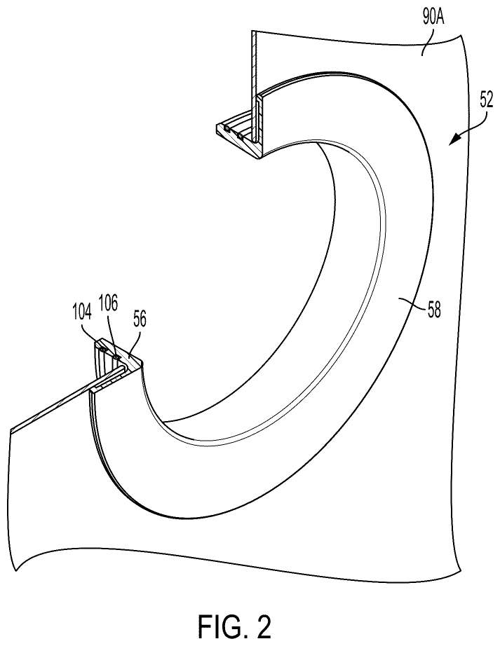

With reference to FIGS. 2, 4 and 5, the neck assembly 50 has a pair of neck components 52, 54. The neck components 52, 54 can optionally have a similar or the same configuration. As such, only the configuration of the neck component 52 is described herein for the sake of simplicity. The illustrated neck component 52 has a main body that has an essentially L-shaped configuration in cross-section. The main body has a first leg portion 56 forming an annular flange element and a perpendicularly disposed second leg portion 58. The illustrated first leg portion 56 has an outer surface 60A and an opposed inner surface 60B. The inner surface 60B can have one or more grooves formed therein. According to one embodiment, the inner surface 60B has a pair of grooves 62 and 64 that are axially spaced apart along the length of the leg 56. The grooves 62, 64 can be configured to seat one or more of a sealing element and a retaining or retention element. For example, the groove 62 can be configured to seat a retaining element 104 and the groove 64 can seat a sealing element 106, such as an O-ring. The sealing element 106 helps form a fluid seal between the neck assembly 50 and the flange assembly 20 so as to prevent a feed fluid from passing therebetween. The retaining element 104 helps secure the neck assembly 50 to the flange assembly 20.

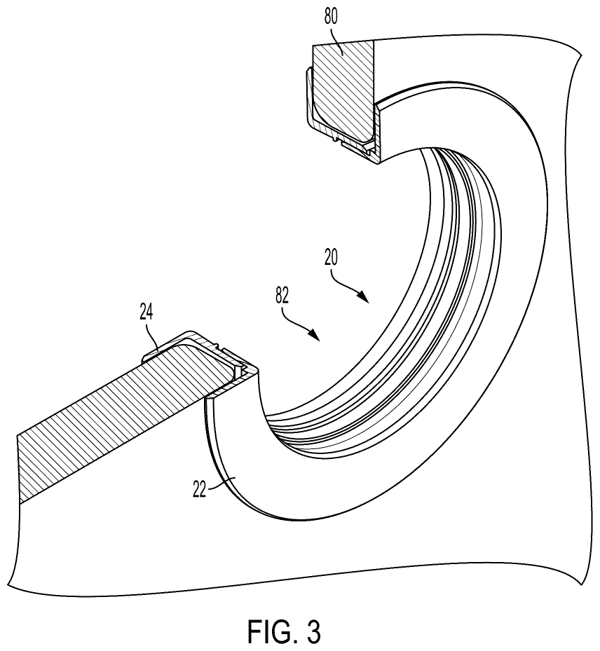

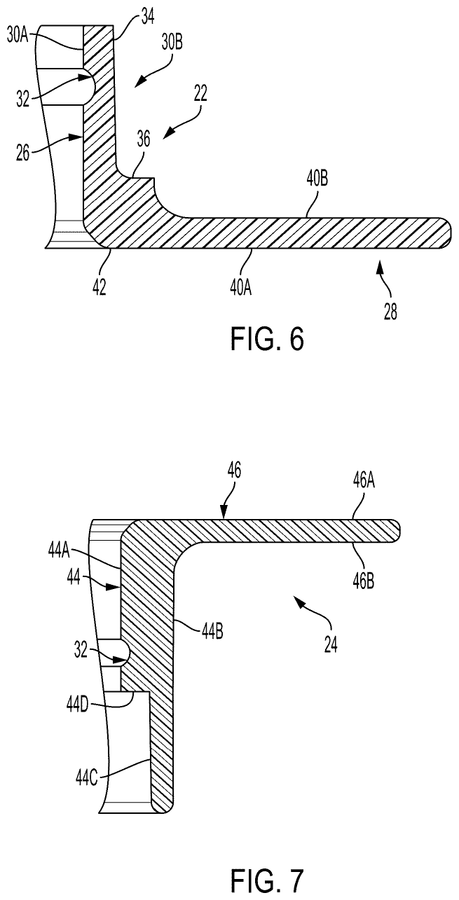

The details of the illustrated flange assembly 20 are shown in more detail in FIGS. 3 and 5-7. The flange component 22 is shown for example in FIG. 6 and the flange component 24 is shown for example in FIG. 7. The illustrated flange component 22 has a main body having a first leg portion 26 that is sized and configured for seating in the feed hole 82 and a perpendicularly disposed second leg portion 28 that is sized and configured for overlying a surface of the filter plate 80. The first leg portion 26 has an outer surface 30A and an opposed inner surface 30B. The outer surface 30A has a groove 32 formed therein for seating a portion of the retaining element 104. The inner surface 30B has a main relatively flat inner surface 34 and a stepped wall surface 36. The second leg portion 28 has an outer surface 40A and an opposed inner surface 40B. The inner surface 40B can transition to the stepped wall surface 36 via a suitable transition surface 42. According to one embodiment, the transition surface can be a curved surface. The grooves 32 and 62 and the retaining element 104 form a retaining or retention mechanism or assembly that secures the neck assembly 50 to the flange assembly 20.

The illustrated flange component 24 has a main body having a first leg portion 44 that is sized and configured for seating in the feed hole 82 and a perpendicularly disposed second leg portion 46 that is sized and configured for overlying a surface of the filter plate 80. The first leg portion 44 has a radially outermost outer surface 44A and an opposed inner surface 44B. The outer surface 44A has a groove 32 formed therein for seating a portion of the retaining element 104, and a stepped radially innermost outer surface 44C coupled to the outer surface 44A by a wall surface 44D. The second leg portion 46 has an outer surface 46A and an opposed inner surface 46B. When coupled together, the inner surface 34 of the flange component 22 directly overlies and contacts the outer surface 46C of the flange component 24. According to one embodiment, a suitable adhesive can be employed to join together the surfaces 34, 46C.

In operation, each of the flange components 22, 24 are positioned on either side of the filter plate 80 in registration with the feed hole 82. The leg portion 26 of the flange component 22 is inserted into the feed hole 82. The flange component 22 can function as a female component of the flange assembly 20. Similarly, the leg portion 44 of the flange component 24 is also inserted into the feed hole 82 and the outer surface portion 44C of the flange component overlies at least a portion of the inner surface 34 of the flange component 22. The flange component 24 can function as a male component of the flange assembly 20. The flange components can move axially relative to each other to accommodate selected thicknesses of the filter plate 80. Once the flange components 22, 24 of the flange assembly 20 are inserted into the feed hole 82, the flange components 22, 24 can be secured together. The flange components can be secured together using known fixation techniques, such as by using a suitable adhesive to secure the inner surface 34 of the flange component 22 to the outer surface 44C of the flange component 24. By securing the flange components together, the flange assembly 20 is fixed in the feed hole 82 and can form a universal connection hub or assembly for connecting the neck assembly 50 thereto. If the filter plate thickness prevents the flange components 22, 24 of the flange assembly 20 from being adequately secured and retained together, then a different configuration of the flange assembly can be used. The alternative configuration can be sufficiently and appropriately sized to accommodate the thickness of the filter plate 80. The flange assembly 20 is employed to create a universal connection hub or assembly that enables the neck assembly 20 to be coupled thereto.

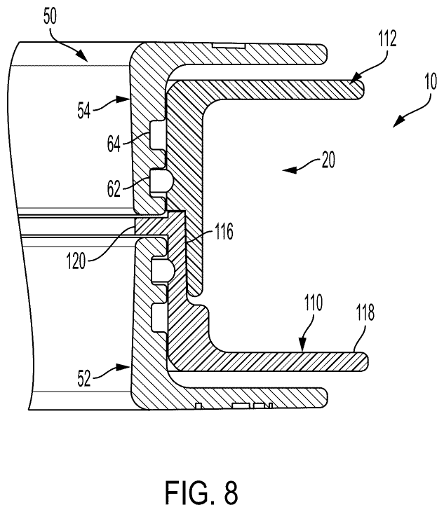

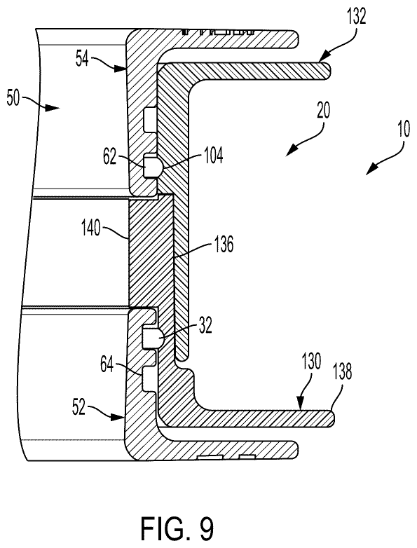

For example, alternative embodiments of the flange assembly 20 are shown in FIGS. 8 and 9. Like reference numerals indicate like parts throughout the various views. As shown for example in FIG. 8, the filter assembly 10 includes a neck assembly 50 having the neck components 52, 54 and a flange assembly 20. The flange assembly 20 can include a first flange component 110 and a second flange component 112. The flange component 110 can have a leg portion 116 and a perpendicularly disposed leg portion 118. The leg portion 116 can have an extension component 120 formed at a terminal end thereof that adds a selected amount of thickness to the flange assembly 20 so as to accommodate filter plates having larger thicknesses. The extension component 120 can be disposed between the neck components 52, 54 of the neck assembly 50 when the filter assembly 10 is assembled on the filter plate 80.

Similarly, FIG. 9 illustrates another embodiment of the filter assembly 10 of the present invention. Like reference numerals indicate like parts throughout the various views. The illustrated filter assembly 10 includes a neck assembly 50 having neck components 52, 54 and a flange assembly 20. The flange assembly 20 can include a first flange component 130 and a second flange component 132. The flange component 130 can have a leg portion 136 and a perpendicularly disposed leg portion 138. The leg portion 136 can have an extension component 140 formed at a terminal end thereof that adds a selected amount of thickness to the flange assembly so as to accommodate filter plates having larger thicknesses. The extension component 140 can be disposed between the neck components 52, 54 of the neck assembly 50 when the filter assembly 10 is assembled on the filter plate 80. The flange components 130, 132 can be used with filter plates 80 having greater thicknesses.

Once the flange assembly 20 is coupled and secured to the filter plate 80, the neck assembly 50 can be coupled thereto. The neck assembly 50 is composed of neck components 52 and 54. Each of the neck components can be separately coupled to a sheet of filter cloth. For example, the neck component 52 can be coupled to filter cloth 90A and the neck component 54 can be coupled to the filter cloth 90B. The filter cloth can be secured to each of the neck components via any suitable fixation techniques, such as by using an adhesive or by radiofrequency welding. If the filter cloth is welded to the neck components, an intermediate component 100, such as a polypropylene ring, can be used. The filter cloth can first be welded to the polypropylene ring, which is in turn secured to the neck component. More specifically, in a press filter assembly, the filter cloth is typically secured to the neck components using radio frequency (RF) welding, a process that joins thermoplastic materials through high-frequency electromagnetic energy. According to one embodiment, a suitable component, such as a polypropylene (PP) ring, is used to facilitate the welding process. The PP ring can be an annular component made of rigid or semi-rigid polypropylene, sized to match the mounting area of the filter plate 80. The purpose of the PP ring is to serve as a weldable intermediary between the filter cloth and the neck components. The PP ring provides a defined target for welding and helps ensure consistent sealing and mechanical stability, especially if the filter cloth itself does not RF weld effectively.

The leg portions 56 of the neck portions 52, 54 also have grooves 62, 64 formed along an inner surface 60B. The groove 64 seats a sealing element 106 and the other groove 62 mounts a retaining element 104. The leg portion 56 of the neck component 52 is configured to seat within the feed hole 82 and the inner surface 60B overlies the outer surface 30A of the flange component 22. The groove 62 mounting the retaining element 104 is then disposed in registration with the groove 32 formed in the flange component 22. The retaining element 104 serves to connect the flange component 22 to the neck component 52 and to retain the components together. The sealing element 106 in the groove 64 forms a seal between the components to help prevent fluid passing through the feed hole 82 from leaking between the flange and neck components. The mounting of the neck component 52 in this manner and securing the neck component 52 to the flange component 22 enables a single connection point to be employed for mounting the filter cloth 90A along one face of the filter plate 80.

Similarly, the leg portion 56 of the neck component 54 is mounted within the feed hole 82 and the inner surface 60B overlies the outer surface 44A of the flange component 24. The groove 62 mounting the retaining element 104 is then disposed in registration with the groove 32 formed in the flange component 24. The retaining element 104 serves to connect the flange component 24 to the neck component 54 and to retain the components together. The sealing element 106 in the groove 64 forms a seal between the components to help prevent fluid passing through the feed hole 82 from leaking between the flange and neck components. The mounting of the neck component 54 in this manner and securing the neck component 54 to the flange component 24 enables a single connection point to be employed for mounting the filter cloth 90B along one face of the filter plate 80. In this manner, if an issue arises (e.g., a tear) with the filter cloth along one of the faces of the filter plate, that specific filter cloth can be removed without having to remove filter cloth from both faces of the filter plate as in conventional systems.

The flange components and the neck components can be formed from any suitable durable material capable of operating with and withstanding the pressures and chemicals used in the filter press. Examples of suitable materials can include plastics such as thermoplastics (e.g., polypropylene), rubber, stainless steel, cast iron, and the like. The filter cloth can be made from any suitable material that can effectively filter out particles from a feed fluid while being resistant to wear and tear. Examples of suitable materials include polyester, polypropylene, nylon and the like. These materials ensure that the filter press operates efficiently and has a long service life.

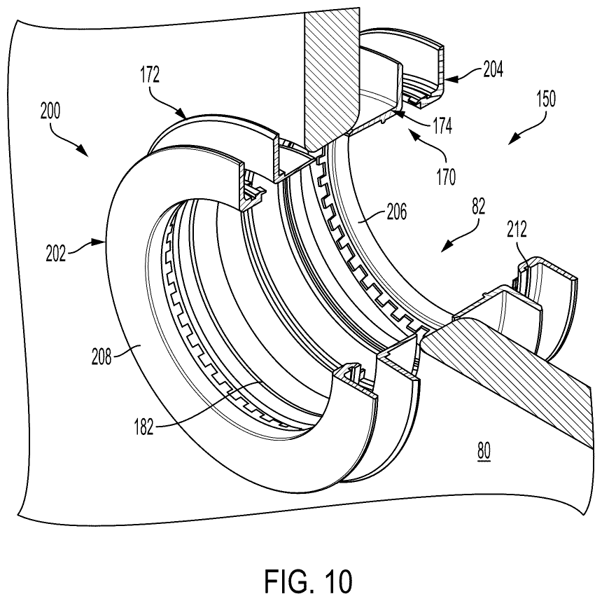

Another embodiment of the filter assembly of the present invention is shown for example in FIGS. 10-13. Like parts are designated with like reference numerals throughout the various views. The illustrated filter assembly 150 includes a flange assembly 170 that can be coupled to a neck assembly 200. The flange assembly 170 can be coupled to a filter plate 80 by seating within a feed hole 82 of the filter plate. The neck assembly 200 can be coupled to one or more sheets of filter cloth 90A, 90B. The illustrated flange assembly 170 can be formed from a first flange component 172 and from a second flange component 174. The first and second flange components 172, 174 can be seated within the feed hole 82 of the filter plate 80 and can be secured together so as to retain the flange assembly 170 within the feed hole 82. The neck assembly 200 can also include a first neck component 202 and a second neck component 204. The first neck component 202 can be coupled to the filter cloth 90A and the second neck component can be coupled to the filter cloth 90B. The neck components 202, 204 can be secured to the filter cloth through any suitable securing or fixation technique, such as for example by using an adhesive or by welding, such as radio frequency welding. The filter cloth can be secured directly to the neck components or can be secured to an intermediate component 100, such as a polypropylene ring, which can be secured to or mechanically retained by the neck components.

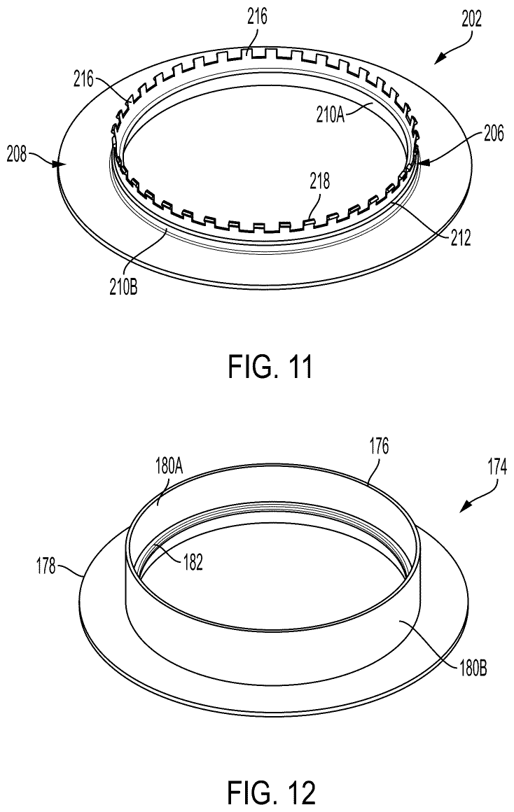

The illustrated neck assembly 200 has a pair of neck components 202, 204. The neck components 202, 204 that have similar or the same structure and configuration. As such, only the configuration of the neck component 202 is described herein for the sake of simplicity. With reference to FIG. 11, the illustrated neck component 202 has an annular main body that has an essentially L-shaped configuration in cross-section. The main body has a first leg portion 206 that is sized and configured for seating in the feed hole 82 and a perpendicularly disposed second leg portion 208. The illustrated first leg portion 206 has an outer surface 210A and an opposed inner surface 210B. The inner surface 210B can have one or more optional grooves 212 formed therein for seating an optional sealing element. The sealing element helps form a fluid seal between the neck assembly 200 and the flange assembly 170 so as to prevent fluid from the feed hole from passing or leaking therebetween. The illustrated leg portion 206 can include a retaining mechanism or assembly for enabling the neck component to be secured to one of the flange components. According to one embodiment, the leg portion 206 terminates in a series of teeth like connection or retaining elements 216 that are circumferentially spaced apart. The teeth elements 216 can include a surface feature, such as a lip element 218, for coupling or connecting to a corresponding surface feature formed on the respective flange component. The surface feature formed on the flange components can be, for example, a groove, a lip element, or some other type of surface feature or protrusion capable of coupling to the retaining elements 216 to hold and secure the neck component to the flange component.

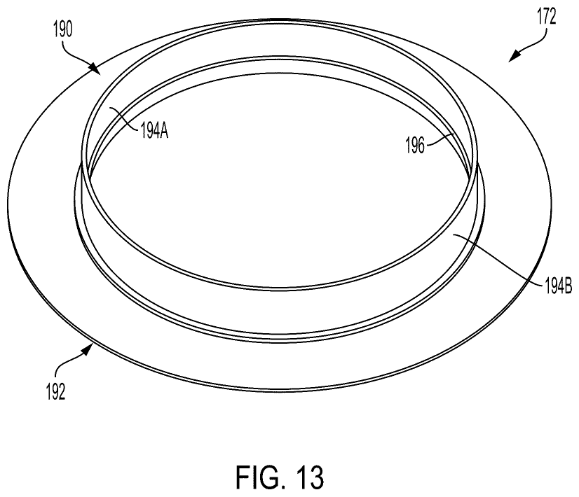

With reference to FIGS. 10 and 12, the illustrated female type flange component 174 has a main body having a first leg portion 176 that is sized and configured for seating in the feed hole 82 and a perpendicularly disposed second leg portion 178 that is sized and configured for overlying a surface of the filter plate 80. The first leg portion 176 has an outer surface 180A and an opposed inner surface 180B. The outer surface 180A has a surface feature, such as a protrusion 182, that is configured to engage with at least a portion of the retaining elements 216. The inner surface 180B is relatively flat for seating against the filter plate 80 in the feed hole 82. As shown in FIGS. 10 and 13, the illustrated male type flange component 172 has a main body having a first leg portion 190 that is sized and configured for seating in the feed hole 82 and a perpendicularly disposed second leg portion 192 that is sized and configured for overlying a surface of the filter plate 80. The first leg portion 190 has an outer surface 194A and an opposed inner surface 194B. The outer surface 194A can include a surface feature, such as a protrusion 196, that is configured to engage with the retaining elements 216. The inner surface 194B has a first outer surface that transitions to a second stepped outer surface. When coupled together, the inner surface 194B of the flange component 172 directly overlies and contacts the outer surface 180A of the flange component 174. According to one embodiment, a suitable adhesive can be employed to join together these two surfaces.

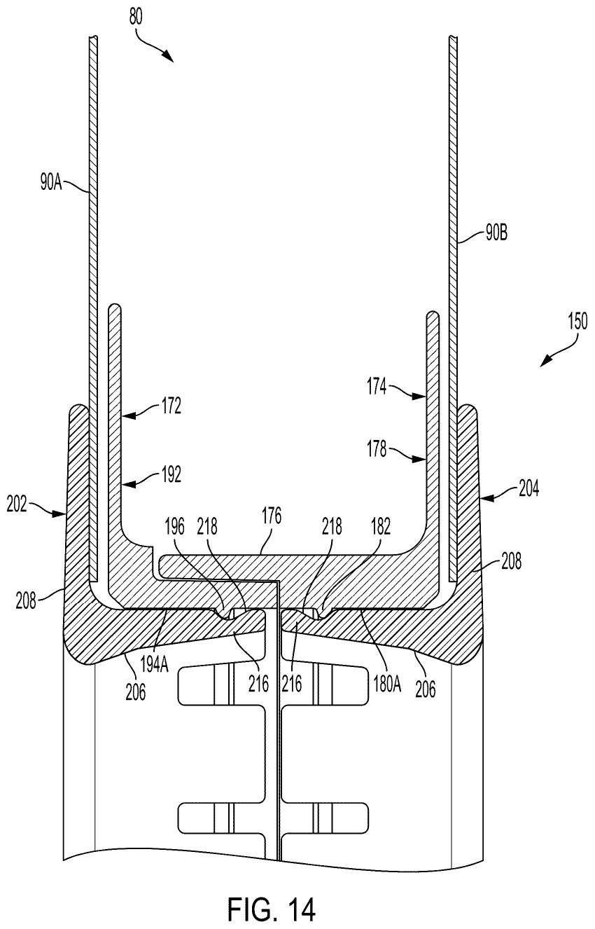

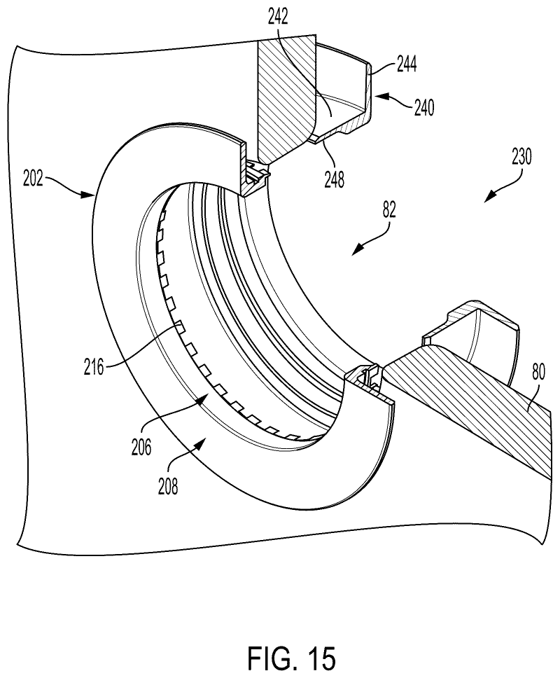

FIG. 14 is a cross-sectional view of the filter assembly 150 showing the engagement of the protrusions 182, 196 of the flange components 172, 174 with the retaining elements 216 of the neck components 202, 204. Specifically, the outer surface 180A of the flange component 174 has the protrusion 182 that engages with a portion (e.g., lip element 218) of the retaining elements 216 of the neck component 204. Similarly, the outer surface 194A of the flange component 172 has a protrusion 196 that engages with a portion (e.g., lip element 218) of the retaining elements 216 of the neck component 202.

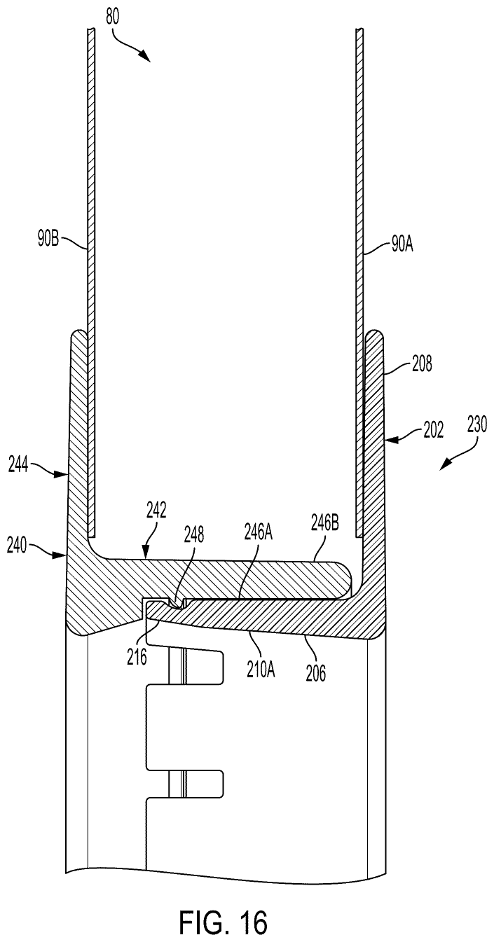

Another embodiment of the filter assembly of the present invention is shown, for example, in FIGS. 15 and 16. Like parts are designated with like reference numerals throughout the various views. The filter assembly can include a combination of a single neck component and a single flange component that can be configured to be coupled together so to connect the components to the filter plate 80. According to one embodiment, the illustrated filter assembly 230 includes a neck component 202 that has a series of retaining elements 216 formed at a terminal end of the leg portion 206. The neck component 202 also has a perpendicularly disposed leg portion 208. The leg portion 208 can be coupled, either directly or through an intermediate element 100, to the filter cloth 90A. The filter assembly 230 can also include a flange component 240 having a main body having a leg portion 242 and a perpendicularly disposed leg portion 244. The leg portion 244 can be coupled, either directly or through an intermediate element, to the filter cloth 90B. The leg portion 242 has an outer surface 246A and an opposed inner surface 246B. The outer surface 246A has a surface feature formed thereon, such as a protrusion 248, that is configured to engage with the retaining elements 216 of the neck component 202. The coupling together of the protrusion 248 with the retaining elements 216 helps connect the neck component 202 to the flange component 240 and help retain the components in the feed hole 82 and to connect the components to the filter plate 80.

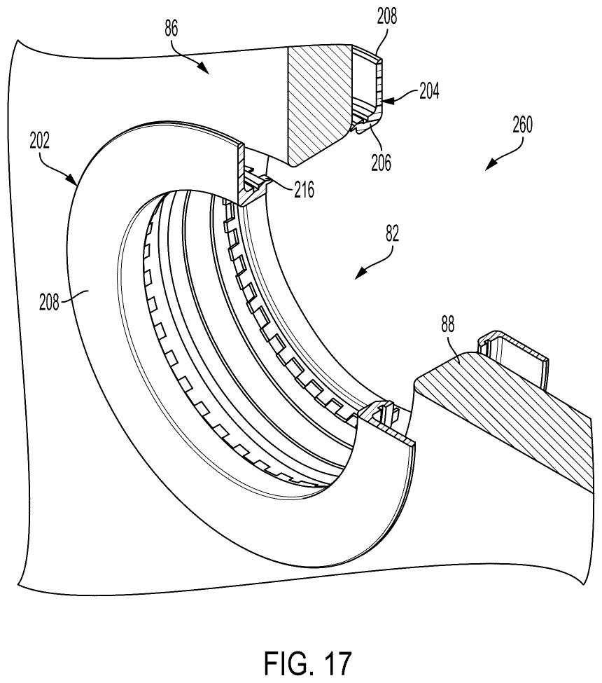

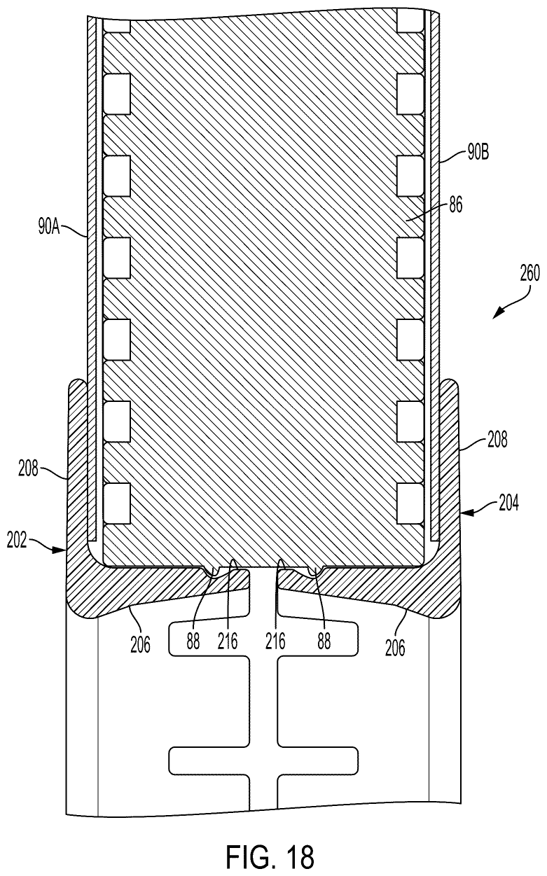

Still another embodiment of the filter assembly of the present invention is shown, for example, in FIGS. 17 and 18. Like parts are designated with like reference numerals throughout the various views. The filter assembly can include a pair of neck components that can be coupled to a specially configured filter plate. According to one embodiment, the filter assembly 260 can include a pair of neck components 202, 204 that can be similar to the neck components of FIG. 10. The neck components 202, 204 can include a leg portion 206 that includes a plurality of retaining elements 216 formed at a terminal end thereof. The leg portion 206 can be perpendicularly disposed relative to leg portion 208. The leg portions can be coupled, either directly or through an intermediate member 100, to the filter cloth 90A, 90B. The filter plate 86 can have a main body having a plurality of surface features formed in the feed hole 82. According to one embodiment, the surface features can include multiple spaced apart annular protrusions 88. The retaining elements 216 of the neck components are configured to engage with the protrusions 88. The engagement of the protrusions 88 with the retaining elements 216 helps secure the neck components to the filter plate 86.

In general, with regard to the filter assembly 10 of the present invention, the neck components 52, 54 of the filter assembly 10 can be coupled to the filter cloth or fabric through an industrially accepted radio frequency welding process. The neck components 52, 54 can be configured to have one or more grooves 64 formed therein for seating a sealing element 106, such as an O-ring, and one or more grooves 62 formed therein for seating a retaining element 104. The sealing O-ring can be configured to seal the neck components relative to the flange components by preventing the slurry (e.g., liquid) being processed and passing through the feed hole 82 from leaking to the back side of the filter cloth 90A, 90B. The retaining element 104, which can be a selected type of O-ring, is configured to connect and retain the neck components 52, 54 to the flange components 22, 24. The retaining O-ring 104 can be formed from any suitable material having a suitable durometer and can have any selected size that is sufficient to hold and retain the neck components in place. The sealing O-ring 106 when installed seats into a predesigned groove 64 formed in the neck components. The O-rings can be changed dimensionally for fit purposes, as well as the material of construction can be changed based on the chemical compatibility needs or durometer needs. The O-rings can be made from any suitable material, such as from rubber or rubber based compositions. The neck components 52, 54 allow for the filter press cloths to be manufactured as a single panel whereas conventional designs require a barrel neck connecting two panels together. The single panel design of the present invention in conjunction with the flange components 22, 24 allows for the cloth to be independently installed quickly and easily from each side of the filter plate. To use the neck components, the customer can initially install the flange components at the feed hole 82 of the filter plate 80. The feed hole 82 can be located in the center of the filter plate 80 or can be offset up or down from a center position, such as for example in one of the four corners of the filter plate 80 or located in a top or bottom exterior feed port location. The flange components 22, 24 can be secured (e.g., glued) together or can be threaded together in the feed hole 82. Once the neck components 22, 24 are secured in place in the feed hole 82, the neck components are not removed unless damaged. The neck components thus form an attachment point or hub, such as for example a universal attachment hub, for the neck components. This arrangement places the filter cloth installation in control as the feed hole dimensions are now a known item and are consistent throughout the entire filter plate stack allowing for the single panel filters with the neck components to be installed. The flange components are the part that allows for the filter cloths 90A, 90B to be easily retrofitted into various designs of filter plates that exist in the industry. The flange components can be manufactured from different types of plastics by injection molding, machining or even three-dimensional (3D) printing. Some of the common plastics that can be used to form the flange components can include polyethylene, polypropylene, nylon, ABS (Acrylonitrile Butadiene Styrene), PVC (Polyvinyl Chloride), and CPVC (Chlorinated Polyvinyl Chloride). Being able to machine or 3D print the flange components allows for subtle changes dimensionally to further tailor the fit to the filter plate 80. The neck components can be made of plastic by machining or injection molding and in some cases 3D printing. The preferred material of construction for the neck components is polypropylene, Nylon, PVC and any other plastics with high dielectric loss factors.

The additional embodiments of the filter assembly of the present invention include neck components 202, 204 that include retaining elements 216 (e.g., teeth) that allow the neck components to be coupled or connected to the flange components 172, 174. For example, the filter assembly 150 allows for connecting/securing the neck components to the flange components by using flexible teeth 216 around the flange components that snaps over a protrusion or ridge 182, 196 formed on the flange components. The teeth 216 when installed are designed to be flexible enough to bend over the protrusions and snap to the backside of the protrusion to hold the neck components in place.

The neck components of the filter assembly of the present invention are installed on each side of the filter plate, eliminating the need to pull the filter cloth through the feed hole 82. This allows for quick assembly/disassembly of the filter plate assembly and extends the life of the filter cloth. This design simplifies assembly and disassembly, extending the life of the filter cloth. Unlike conventional filters, which require replacing both panels if one is damaged, the neck components allow for single-side replacement. The filter cloth with neck components attaches and detaches quickly and easily from the filter plate. Additionally, the neck components provide a seal to the flange components, eliminating the need for secondary sealing devices. These neck components are straightforward to fit and retrofit to existing filter plates.

It will thus be seen that the invention efficiently attains the objects set forth above, among those made apparent from the preceding description. Since certain changes may be made in the above constructions without departing from the scope of the invention, it is intended that all matter contained in the above description or shown in the accompanying drawings be interpreted as illustrative and not in a limiting sense.

It is also to be understood that the following claims are to cover all generic and specific features of the invention described herein, and all statements of the scope of the invention which, as a matter of language, might be said to fall therebetween.

Having described the invention, what is claimed as new and desired to be secured by Letters Patent is:

We claim:

1. A filter assembly for use with one or more filter plates in a filter press, wherein the filter plate has a feed hole formed therein, comprising
a flange assembly having a first flange component and a second flange component, wherein at least a portion of the first flange component and the second flange component are configured to seat within the feed hole, and
a neck assembly having a first neck component configured to be coupled to a first filter cloth and mountable on a first side of the filter plate, and a second neck component configured to be coupled to a second filter cloth and mountable on a second opposed side of the filter plate, wherein at least a portion of the first neck component is configured to be coupled to the first flange component in the feed hole and at least a portion of the second neck component is configured to be coupled to the second neck component in the feed hole.

2. The filter assembly of claim 1, wherein the first flange component has a first leg portion configured to seat within the feed hole and a second leg portion configured to overlie a portion of the first side of the filter plate, wherein the first leg component of the first flange component has a first groove formed therein for seating a portion of a first retaining element, and
wherein the second flange component has a first leg portion configured to seat within the feed hole and a second leg portion configured to overlie a portion of the second side of the filter plate, wherein the first leg component of the second flange component has a second groove formed therein for seating a portion of a second retaining element.

3. The filter assembly of claim 2, wherein the first neck component has a first leg portion configured to seat within the feed hole and positioned to overlie the first leg portion of the first flange component and a second leg portion configured to be coupled to the first filter cloth, wherein the first leg component of the first neck component has a first groove formed therein for seating a portion of the first retaining element,
wherein the second neck component has a first leg portion configured to seat within the feed hole and positioned to overlie the first leg portion of the second flange component and a second leg portion configured to be coupled to the second filter cloth, wherein the first leg component of the second neck component has a second groove formed therein for seating a portion of the second retaining element.

4. The filter assembly of claim 3, wherein the first leg portion of each of the first and second neck components has a second groove formed therein for seating a sealing element, wherein the sealing elements form a seal between the neck assembly and the flange assembly.

5. The filter assembly of claim 4, wherein the first leg portions of the first and second flange components are configured to be secured together in the feed hole to secure the first and second flange components to the filter plate.

6. The filter assembly of claim 5, wherein the first retaining element secures the first neck component to the first flange component and the second retaining element secures the second neck component to the second flange component.

7. The filter assembly of claim 6, further comprising a first intermediate element for coupling the first filter cloth to the first neck component and a second intermediate element for coupling the second filter cloth to the second neck component.

8. The filter assembly of claim 6, wherein the first leg portion of the first flange component has an extension component formed at a terminal end thereof.

9. The filter assembly of claim 6, wherein the first leg component of the first neck component has a sealing groove formed therein for seating a first sealing element, and wherein the first leg component of the second neck component has a sealing groove formed therein for seating a second sealing element,
wherein the first and second sealing elements form a seal between the neck assembly and the flange assembly.

10. The filter assembly of claim 1, wherein the first flange component has a first leg portion configured to seat within the feed hole and a second leg portion configured to overlie a portion of the first side of the filter plate, and wherein the second flange component has a first leg portion configured to seat within the feed hole and a second leg portion configured to overlie a portion of the second side of the filter plate,
wherein the first neck component has a first leg portion configured to seat within the feed hole and positioned to overlie the first leg portion of the first flange component and a second leg portion configured to be coupled to the first filter cloth, and the second neck component has a first leg portion configured to seat within the feed hole and positioned to overlie the first leg portion of the second flange component and a second leg portion configured to be coupled to the second filter cloth.

11. The filter assembly of claim 10, wherein the first leg portion of the first flange component has a first surface feature associated therewith and wherein the first leg portion of the second flange component has a second surface feature associated therewith,
wherein the first leg portion of the first neck component has a first retaining assembly associated therewith and the first leg portion of the second neck component has a second retaining assembly associated therewith.

12. The filter assembly of claim 11, wherein the first retaining assembly includes a plurality of teeth elements configured for coupling to the first surface feature for coupling together the first leg portion of the first neck component to the first leg portion of the first flange component, and wherein the second retaining assembly includes a plurality of teeth elements configured for coupling to the second surface feature for coupling together the first leg portion of the second neck component to the first leg portion of the second flange component.

13. The filter assembly of claim 12, wherein the first surface feature and the second surface feature include a protrusion.

14. The filter assembly of claim 12, wherein the first leg component of the first flange component has a first groove formed therein that is sized and configured for seating a first sealing element and wherein the first leg component of the second flange component has a second groove formed therein that is sized and configured for seating a second sealing element.

15. A filter assembly for use with one or more filter plates in a filter press, wherein the filter plate has a feed hole formed therein, comprising
a flange component mounted on a first side of the filter plate and having a first leg portion that is configured to seat within the feed hole and a second leg portion that is configured to be coupled to a first filter cloth, and
a neck component separate and distinct from the flange component mounted on a second side of the filter plate and having a first leg portion that is configured to seat within the feed hole and configured to be coupled to the first leg portion of the flange component and a second leg portion that is configured to be coupled to a second filter cloth.

16. The filter assembly of claim 15, wherein the first leg portion of the flange component has a flange surface feature associated therewith and the first portion of the neck component has a neck surface feature associated therewith, and wherein the flange surface feature and the neck surface feature are configured to be coupled together to secure the flange component to the neck component.

17. The filter assembly of claim 16, wherein the neck surface feature includes a plurality of retaining elements and wherein the flange surface feature includes one or more protrusions.

18. The filter assembly of claim 17, wherein the plurality of retaining elements comprises a plurality of teeth elements.

19. A filter assembly for use with one or more filter plates in a filter press, wherein the filter plate has a feed hole having a first annular protrusion and a second annular protrusion formed thereon, comprising
a first neck component mounted on a first side of the filter plate and having a first leg portion that is configured to seat within the feed hole and a second leg portion that is configured to be coupled to a first filter cloth, wherein the first leg portion has a first surface feature formed thereon configured for coupling to the first annular protrusion of the feed hole to secure the first neck component to the first side of the filter plate, and
a second neck component mounted on a second side of the filter plate and having a first leg portion that is configured to seat within the feed hole and a second leg portion that is configured to be coupled to a second filter cloth, wherein the first leg portion has a second surface feature formed thereon configured for coupling to the second annular protrusion of the feed hole to secure the second neck component to the second side of the filter plate.

20. The filter assembly of claim 19, wherein the first surface feature includes a plurality of retaining elements and wherein the second surface feature includes a plurality of retaining elements.
